(19) United States
(12) Patent Application Publication
(10) Pub. No.: US 2004/0125471 A1
(43) Pub. Date: Jul. 1, 2004

(54) Projection lens regulator for rear projection television

(76) Inventor: Jones Chen, Taichung (TW)

Correspondence Address: BACON & THOMAS, PLLC, 625 SLATERS LANE, FOURTH FLOOR, ALEXANDRIA, VA, 22314

(21) Appl. No.: 10/408,556

(22) Filed: Apr. 8, 2003

(30) Foreign Application Priority Data
Dec. 31, 2002 (CN) 02295470.8

(51) Int. Cl. G02B 15/14; G02B 7/02

(52) U.S. Cl. 359/811; 359/694; 359/819

(57) ABSTRACT

A projection lens regulator for a projection TV is disclosed to include of a base, a barrel, and an adjusting hoop. The base includes at least one guide slot positioned radially at a peripheral wall thereof. The barrel is fitted inside the base and includes at least one slope guide groove positioned radially at a peripheral wall thereof. The adjusting hoop is fitted on the base. At least one slide member is mounted on the adjusting hoop and inserted into the guide groove of the barrel through the guide slot of the base. The adjusting hoop is turned to drive the slide member to move along the slope guide groove of the barrel, and then the slide member drives the barrel to move with respect to the base axially.

### BACKGROUND OF THE INVENTION

1. Field of the Invention

The present invention relates generally to a projection lens of a rear projection television (TV), and more particularly to an improved projection lens regulator for the rear projection TV.

2. Description of the Related Art

A conventional projection lens regulator for a rear projection TV, as shown in FIG. 1, is composed of a base 1′ disposed with lenses (not shown) at a bottom side thereof, a barrel 2′ fitted inside the base 1′, and a projection lens (not shown) mounted inside the barrel 2′. The projection lens regulator is operated to adjust the relative position between the lenses (not shown) and the barrel 2′, thereby making visual images to be formed on the TV clear. The base 1′ includes two slope guide slots 11′ positioned symmetrically at a peripheral wall thereof. The barrel 2′ includes two columns 21′ protruded from an outer peripheral wall thereof and corresponding to the two slope guide slots 11′ for running through the two slope guide slots 11′. Two butterfly-shaped nuts 12′ are respectively threadedly mounted on the two columns 21′. While the regulator is operated to adjust the aforementioned relative position, the nuts 12′ are screwed loosely and then the two columns 21′ are moved respectively along the two slope guide slots 11′ at the same time to drive the barrel 2′ to move axially with respect to the base 1′, such that the visual images can be adjustably formed. While the aforementioned relative position is rendered optimally, the nuts 12′ are screwed tight to fasten the base 1′ and the barrel 2′ together.

While the aforementioned regulator is operated, the barrel not only moves axially but also rotates with respect to the base such that it's practically laborsome to operate the barrel that is preferably heavy. In addition, while the aforementioned relative position is rendered optimally, the two butterfly nuts have to be screwed tight at the same time such that the operation is complicated and subject to randomize the focal length of the projection lens so as to further reduce the quality of the visual images. Moreover, the slope guide slots are exposed outside to get dusty easily and to uglify the regulator.

### SUMMARY OF THE INVENTION

The primary objective of the present invention is to provide an improved projection lens regulator, which is laborsaving and easy to be operated and which is rapid to render a focal length and a fixed position of a projection lens

The foregoing objective of the present invention is attained by the projection lens regulator, which is composed of a base, a barrel fitted inside the base, and an adjusting hoop fitted on the base. The base has at least one guide slot. The barrel has at least one slope guide groove corresponding in location to the guide slot of the base. And, at least one slide member is mounted on said adjusting hoop and protruded through said guide slot of said base into said guide groove of said barrel.

Wherein the base is provided with at least one guide hole and the barrel is provided with at least one locking seat corresponding to the guide hole.

Wherein the barrel includes two of the slope guide grooves positioned relatively and symmetrically at the peripheral wall thereof, and the base includes two of said guide slots positioned relatively and symmetrically at the peripheral wall thereof. The adjusting hoop includes at least one unit of a concave portion and a convex portion at an inner side thereof for positioning the slide member.

Wherein the barrel is further provided with a guide rail positioned axially at an outer peripheral wall thereof and said base is further provided with a guide rib at an inner peripheral wall thereof. The guide rib traverses in the guide rail.

Wherein the base and the barrel are fastened with each other by a locking member connected to the locking seat.

Wherein the adjusting hoop is further provided with at least one through hole for a bolt running through to fasten the slide member thereto.

### BRIEF DESCRIPTION OF THE DRAWINGS

FIG. 1 is a perspective view of a prior art;

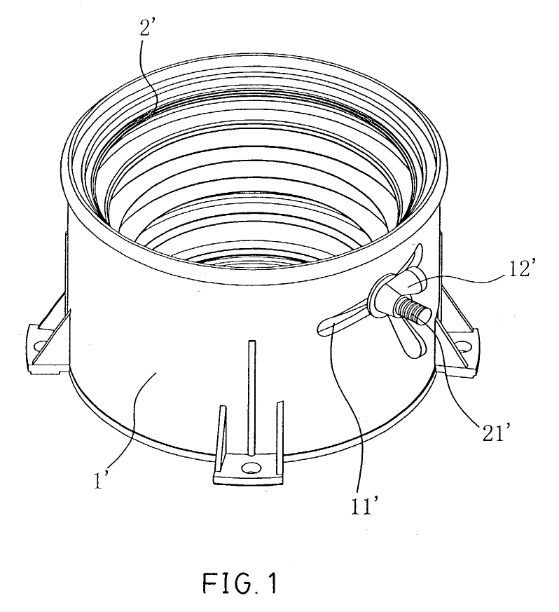

FIG. 2 is an exploded view of a preferred embodiment of the present invention;

FIG. 3 is an exploded view of an adjusting hoop of the preferred embodiment of the present invention;

FIG. 4 is a perspective view of the preferred embodiment of the present invention; and

FIG. 5 is a schematic view of the preferred embodiment of the present invention at work.

### DETAILED DESCRIPTION OF THE INVENTION

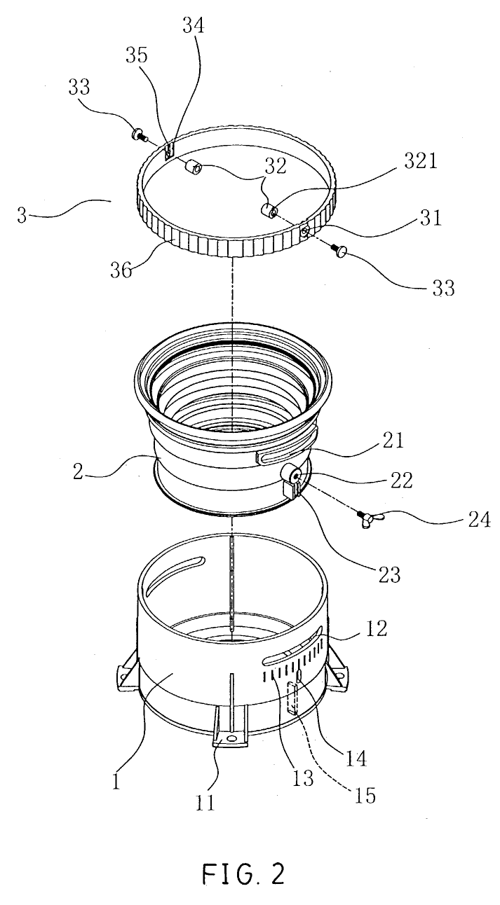

Referring to FIG. 2, a projection lens regulator for a projection TV is composed of a base 1, a barrel 2, and an adjusting hoop 3.

The base 1 is a bucket-shaped member and includes at least one lens (not shown) positioned at a bottom side thereof, a plurality of fixtures 11 at a lower side of an outer peripheral wall thereof for fastening with other objects, two guide slots 12 positioned relatively and symmetrically at an upper side of a peripheral wall thereof, a scale 13 positioned under an outer side of the guide slot 12, a guide hole 14 positioned under the outer side of the guide slot 12, and a guide rib 15 protruded at an inner peripheral wall of the base 1.

The barrel 2 is a bucket-shaped member and includes a projection lens (not shown) inside, two slope guide grooves 21 positioned at an outer peripheral wall thereof and respectively corresponding to the two guide slots 12 of the base 1, a locking seat 22 protruded outwards at the outer peripheral wall thereof and corresponding to the guide hole 14 of the base 1, a guide rail 23 positioned at the outer peripheral wall thereof and corresponding to the guide rib 15 of the base 1.

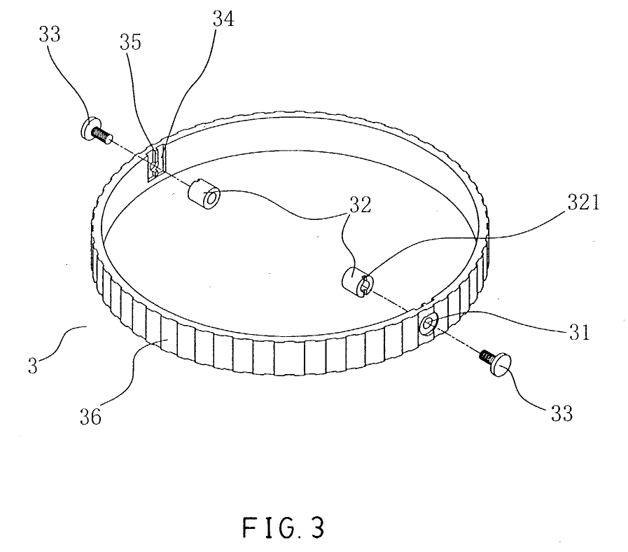

Referring to FIG. 3, the adjusting hoop 3 is an annular member and includes two through holes 31 positioned relatively and symmetrically at a peripheral wall thereof, two slide members 32 mounted at an inner side thereof by two bolts 33 respectively running through the two through holes 31, and two units of a concave portion 34 and a convex portion 35 positioned at the inner side thereof and at the through holes 31 for setting the slide members 32 in position. The slide members 32 are respectively provided with a recessed portion 321 corresponding to the convex portion 35 of the adjusting hoop 3 and a convexoconcave surface 36 positioned at an outer peripheral wall thereof for enhancing friction.

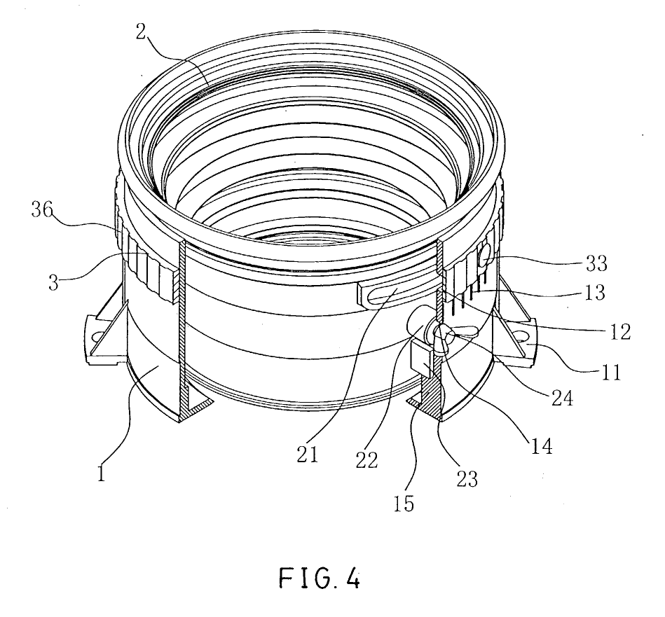

Referring to FIG. 4, while the projection lens regulator is assembled, the barrel 2 is fitted inside the base 1, and meanwhile, the guide rail 23 of the barrel 2 cooperates with the guide rib 14 of the base 1 to keep the barrel 2 moving axially with respect to the base 1. The slide members 32 are inserted through the guide slots 12 and into the slope guide grooves 21 and have the recessed potions 321 facing outwards. The convex portions 35 of the adjusting hoop 3 are respectively aligned with and fitted with the recessed portions 321 of the slide members 32. The bolts 33 runs through the through holes 31 to keep the adjusting hoop 3 and the slide members 32 fastened with each other.

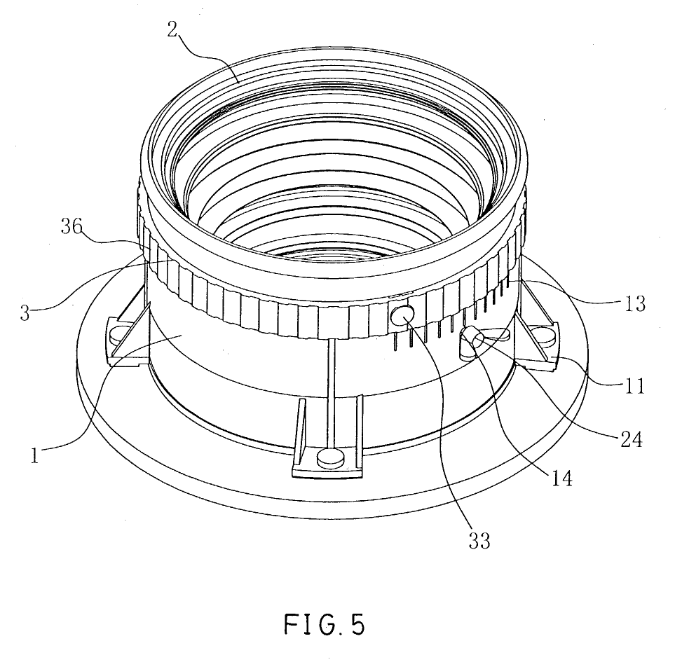

While the projection lens regulator of the present invention is operated to make the visual images to be formed on the TV clear, as shown in FIG. 5, the adjusting hoop 3 is turned horizontally to drive the slide members 32 to rotate inside the guide slots 12 rather than to move axially. While the slide members 32 move along the slope guide grooves 21, the barrel 2 will be driven to move axially with respect to the base 1, thereby adjusting the projection lens. Moreover, the locking seat 22 of the barrel 2 is always radially aligned with the guide hole 14 of the base 1. While the projection lens is adjusted to a proper position, the barrel 2 and the base 1 can be fastened with each other by a locking member 24 to stop the adjusting hoop 3 from further moving.

What is claimed is:

1. A projection lens regulator for a projection television, said projection lens regulator comprising:
a base having at least one guide slot positioned radially at a peripheral wall thereof;
a barrel fitted inside said base and having at least one slope guide groove positioned radially at a peripheral wall thereof;
an adjusting hoop fitted on said base; and
at least one slide member mounted on said adjusting hoop and protruded through said guide slot of said base into said guide groove of said barrel.

2. The projection lens regulator as defined in claim 1, wherein said base is provided with at least one guide hole positioned axially at the peripheral wall thereof, and said barrel is provided with at least one locking seat positioned at the peripheral wall thereof and corresponding to said guide hole.

3. The projection lens regulator as defined in claim 1, wherein said barrel includes two of said slope guide grooves positioned relatively and symmetrically at the peripheral wall thereof, said base includes two of said guide slots positioned relatively and symmetrically at the peripheral wall thereof, and said adjusting hoop includes at least one unit of a concave portion and a convex portion at an inner side thereof for positioning said slide member.

4. The projection lens regulator as defined in claim 3, wherein said slide member includes a recessed portion corresponding to said convex portion of said adjusting hoop.

5. The projection lens regulator as defined in claim 1, wherein said barrel is further provided with a guide rail positioned axially at an outer peripheral wall thereof and said base is further provided with a guide rib at an inner peripheral wall thereof, said guide rib traversing in said guide rail.

6. The projection lens regulator as defined in claim 2, wherein said base and said barrel are fastened with each other by a locking member connected to said locking seat.

7. The projection lens regulator as defined in claim 1, wherein said base is further provided with a scale positioned over or under said guide slot.

8. The projection lens regulator as defined in claim 1, wherein said adjusting hoop is further provided with at least one through hole for a bolt running through to fasten said slide member thereto.
